(19) United States
(12) Patent Application Publication
(10) Pub. No.: US 2004/0128231 A1
(43) Pub. Date: Jul. 1, 2004

(54) Communication method, carrier apparatus and line lender apparatus

(76) Inventor: Masahiro Morita, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/476,886

(22) PCT Filed: May 15, 2002
(86) PCT No.: PCT/JP02/04709

(30) Foreign Application Priority Data
May 15, 2001 (JP) 2001-145110

(51) Int. Cl. G06F 17/60

(52) U.S. Cl. 705/38

(57) ABSTRACT

A communication method is disclosed in which a terminal communicates with a communication apparatus on the Internet via a carrier apparatus. The terminal communicates with the carrier apparatus by borrowing a part or all of the bandwidth of a broadband communication line, used by a line lender apparatus that lends a line, between the line lender apparatus and the carrier apparatus.

### TECHNICAL FIELD

The present invention relates to a communication method, a carrier apparatus and a line lender apparatus. More particularly, the present invention relates to a communication method, a carrier apparatus and a line lender apparatus that enable borrowing and lending of a part or all of the bandwidth of a broadband communication line between a terminal and the carrier apparatus.

### BACKGROUND ART

As the Internet becomes more widespread, broadband services that enable use of the Internet with high speed in each home are appearing. There are a plurality of methods for providing the broadband services, in which the communication speed for the broadband services is 20 to 100 or more times greater than that of conventional services.

For example, as to a method using optical fiber in which each home and the carrier are connected via optical fiber, the communication speed is equal to or greater than 100 megabits per second. As to an ADSL (Asymmetric Digital Subscriber Line) method using existing copper wires, the communication speed is equal to or greater than 16 megabits per second. As to a CATV method using existing CATV (cable television) lines, the communication speed is equal to or greater than 14.3 megabits per second. As to a radio method in which each home and connection points are connected by radio, and the connection points and the carrier are connected by optical fiber, the Internet can be used with a communication speed of equal to or greater than 1.5 megabits per second.

By the way, since broadband Internet connectivity is expensive, there is a problem in that the cost may inhibit wider use of the broadband services.

In addition, under present circumstances, content requiring broadband Internet connectivity is not sufficiently provided. Therefore, there is a problem in that there remains unused capacity even though, for example, a line of 10 megabits per second is provided between a home and the carrier.

In addition, many of the broadband services are wired services. Although there are some wireless services (for example, FWA (Fixed Wireless Access), W-CDMA (Wideband Code Division Multiple Access)), an enormous investment is necessary for installing base stations for providing wireless broadband services. Thus, the broadband services that can be used when one is away from home or one is on the go are not sufficiently widely available. As a result, there is a problem in that a mobile user needs to use a public telephone or a mobile phone or the like to access the Internet when the user is away from home.

### DISCLOSURE OF THE INVENTION

A general object of the present invention is to provide an improved communication method, a carrier apparatus and a line lender apparatus to solve the above-mentioned problems of the prior art.

A detailed object of the present invention is to provide a communication method, a carrier apparatus and a line lender apparatus to make ease the mobile use of a terminal and to enable borrowing and lending of a part or all of the bandwidth of a broadband communication line between the terminal and the carrier apparatus.

To achieve the above-mentioned object, the present invention is a communication method, a carrier apparatus and a line lender apparatus in which a terminal (for example, a mobile PC 40 in FIG. 1, or, a PC of a neighboring house and the like) communicates with a communication apparatus on the Internet via a carrier apparatus, wherein: the terminal communicates with the carrier apparatus by borrowing a part or all of the bandwidth of a broadband communication line, used by a line lender apparatus that lends a line (for example, a line lender 30 in FIG. 1; in addition, in a case where the carrier directly installs a wireless base station such as wireless LAN claimed in claim 2 to provide the service of the present invention, the carrier becomes the line lender), between the line lender apparatus and the carrier apparatus.

According to the present invention, by communicating with the carrier apparatus by borrowing a part or all of the bandwidth of a broadband communication line, used by the line lender apparatus that lends a line, between the line lender apparatus and the carrier, mobile use of a terminal is made easier, and the communication method, the carrier apparatus and the line lender apparatus to enable borrowing and lending of a part or all of the bandwidth of a broadband communication line between the terminal and the carrier apparatus can be provided.

From the viewpoint of communications between the terminal and the line lender apparatus, the communications between the terminal and the line lender apparatus may be performed via a wireless LAN that is provided in the line lender apparatus.

Accordingly, the mobile terminal in the present invention can easily use the bandwidth of the line used by the line lender apparatus.

From the viewpoint of communications between the terminal and the carrier apparatus, the communications between the terminal and the carrier apparatus may be performed by encrypting a sending signal in the sending side and decoding a received signal in the receiving side.

According to the present invention, since tapping of communication information in the line lender apparatus can be prevented, the terminal can borrow a line from the line lender apparatus without anxiety.

From the viewpoint of authentication between the terminal and the carrier apparatus, the terminal and the carrier apparatus may authenticate each other before the terminal communicates with the communication apparatus on the Internet via the carrier apparatus.

Accordingly, the carrier apparatus in the present invention can authenticate the mobile PC, so that the carrier can verify that the mobile PC is a registered one, and can verify that the mobile PC is one from which a rental fee can be collected with reliability. In addition, the mobile PC can verify that it connects to a valid carrier by authenticating the carrier apparatus.

From the viewpoint of authentication between the terminal and the line lender apparatus, the terminal and the line lender apparatus authenticate each other before the terminal performs communications via the line lender apparatus.

Accordingly, before the terminal in the present invention performs communications via the line lender apparatus, the terminal and the line lender apparatus can authenticate each other. Accordingly, an invalid third party using the line lender apparatus without permission so that the invalid third party performs communications just like a valid terminal of the line lender can be prevented.

From the viewpoint of fees paid to the carrier by the line lender, a fee to be paid to the carrier can be decreased according to the amount of line that is lent by the line lender apparatus.

Accordingly, fees of line use imposed on the line lender can be reduced, so that the spread of broadband can be accelerated.

### BRIEF DESCRIPTION OF THE DRAWINGS

Other objects, features and advantages of the present invention will become more apparent from the following detailed description when read in conjunction with the accompanying drawings.

FIG. 1 is a figure for explaining an entire configuration example;

FIG. 2 is a figure for explaining a configuration example of a carrier apparatus;

FIG. 3 is a figure for explaining a configuration example of a line lender apparatus;

FIG. 4 is a figure for explaining a communication method for performing communications by borrowing a part or all of the bandwidth of a broadband communication line, used by the line lender apparatus, between the line lender apparatus and the carrier;

FIG. 5 shows a configuration example of a customer information database; and

FIG. 6 shows a configuration example of a billing information database.

In the above-mentioned figures, 1 indicates a communication apparatus, 10 indicates the Internet, 20 indicates the carrier apparatus, 21, 22 and 31 indicate routers, 23 indicates an authentication apparatus, 24 indicates a billing apparatus, 25 indicates the customer information database, 26 indicates the billing information database, 27 and 37 indicate LANs, 28 indicates an encryption apparatus, 30 indicates the line lender apparatus, 32 indicates a PC, 33 indicates a line control apparatus, 34 indicates a wireless LAN apparatus, 35 indicates an antenna, and 40 indicates a mobile PC.

### PREFERRED EMBODIMENTS FOR CARRYING OUT THE INVENTION

Embodiments of the present invention are described with reference to figures.

(Example of Whole Configuration)

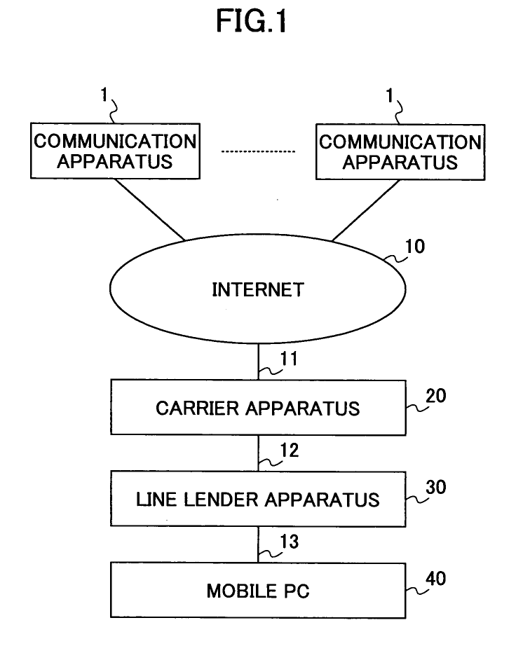

An example of the whole configuration is described next with reference to FIG. 1. The system shown in FIG. 1 includes the Internet 10 that is connected to a plurality of communication apparatuses 1. A plurality of carrier apparatuses 20 are further connected to the Internet 10. A plurality of line lender apparatuses 30 are connected to the carrier apparatuses 20. Mobile PCs (Personal Computer) 40 are connected to a line lender apparatus 30 as necessary. The mobile PC 40 may by a terminal dedicated for mobile use, or may be a terminal, usually used as a home PC, that uses the Internet via a fixed network and that can also serve as a mobile use terminal by inserting a LAN interface card for wireless LAN. The communication apparatus 1 is a communication apparatus that performs communications on the Internet, in which the communication apparatus 1 may be a terminal, a server and the like.

As described later in detail, the mobile PC 40 performs communications with the carrier apparatus 20 by borrowing a part or all of the bandwidth of a broadband communication line between the line lender apparatus 30 and the carrier that is used by the line lender apparatus 30. Further, the mobile PC 40 performs communications with the communication apparatus 1 on the Internet via the carrier apparatus 20.

(Configuration Example of Carrier Apparatus)

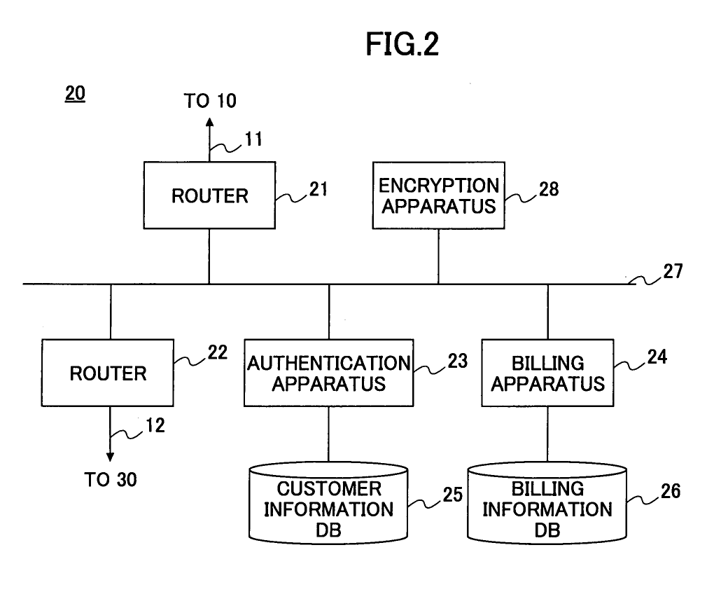

A configuration example of the carrier apparatus 20 is described next with reference to FIG. 2. The carrier apparatus shown in FIG. 2 includes a router 21 for the Internet 10, a router 22 for the line lender apparatus 30, an authentication apparatus 23, a billing apparatus 24, a customer information database 25, a billing information database 26, a LAN (Local Area Network) 27 and an encryption apparatus 28.

The router 21 performs routing of packets between the LAN 27 and the Internet 10. For example, the router 21 captures a packet destined for the router 21 itself from the Internet 10, and transfers a received packet to another router according to a predetermined routing protocol if the received packet is not destined for the router 21 itself. In addition, the router 21 sends a packet to the Internet 10 if the packet is destined for the Internet 10 among packets transmitted in the LAN 27.

The router 22 performs routing for packets between the LAN 27 and the line lender apparatus 30. For example, the router 22 captures a packet destined for the router 22 itself, and sends a packet, among packets in the LAN 27, destined for the line lender apparatus 30 to the line lender apparatus 30.

The authentication apparatus 23 includes the customer information database 25 that stores information on customers of the carrier. The authentication apparatus 23 authenticates the mobile PC 40 by referring to the customer information database 25 before the mobile PC 40 communicates with a communication apparatus on the Internet. In addition, although not shown in the figure, each of the mobile PC 40 and the line lender apparatus 30 includes authentication means, so that the carrier apparatus 20, line lender apparatus 30 and the mobile PC 40 can be authenticated mutually.

In addition, the mobile PC 40 includes an IC card that stores authentication information of itself, so that the mobile PC 40 may send authentication information of the IC card to the authentication apparatus 23 of the carrier apparatus 20 when mutual authentication is performed.

The carrier apparatus 20 verifies whether the mobile PC 40 is a registered one by authenticating the mobile PC 40 so that the carrier apparatus 20 can verify whether the user of the mobile PC is one from which fees can be collected with reliability.

In addition, the mobile PC 40 can verify that it connects to a valid carrier by authenticating the carrier apparatus 20.

In addition, the mobile PC 40 can verify that the line lender is valid and is connected to a valid carrier by authenticating the line lender apparatus 30.

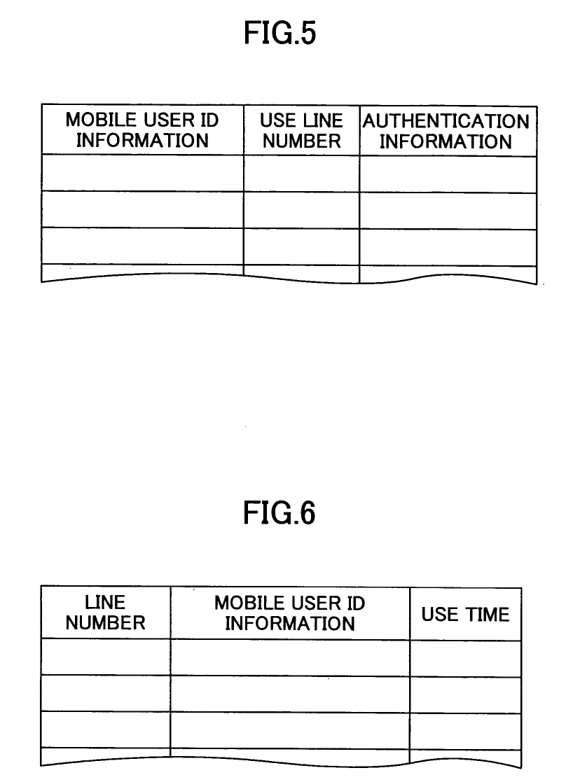

FIG. 5 shows an example of the customer information database 25. The customer information database includes ID information of a mobile user for identifying the mobile PC, use line number and authentication number and the like.

The billing apparatus 24 stores usage of a line lent to the mobile PC for each line lender, and billing is performed on the basis of data stored in the information database 26.

FIG. 6 shows an example of the billing information database 25. The billing information database of FIG. 6 includes line number, ID information of mobile user for specifying the mobile PC and use time and the like.

As methods for billing a line borrower (the mobile PC 40 here), the following methods can be applied, for example. Although not shown in the figure, necessary data are obtained and stored in the billing information database 25 according to the billing methods such that billing to the line borrower can be performed.

First method: A time at which the mobile PC connects to the line and a time at which the connection ends are obtained, and the billing is performed on the basis of the time period between the times. The time at which the connection ends can be determined as the time at which no return message is received in response to sending inquiring messages at predetermined intervals from the billing apparatus of the carrier to the mobile PC.

Second method: Billing is performed by recording the number of packets passed through the line for the mobile PC.

Third method: Billing is performed by recording the sum of the number of bytes of packets passed through the line for the mobile PC.

Fourth method: The mobile PC buys out the bandwidth of the line for a predetermined time. There is no additional fee regardless of usage of the line within the range of the buyout. However, there is no refund even if unused bandwidth remains.

Although not shown in the figure, the encryption apparatus 28 includes an encryption part for encrypting a sending signal to the mobile PC and a decoding part for decoding an encrypted signal received from the mobile PC. The mobile PC includes the same encryption apparatus.

The encryption apparatus 28 exchanges encryption keys secret from third parties that are used for communication between the mobile PC and the encryption apparatus 28. By using the secret keys, the encryption apparatus of the carrier and the encryption apparatus of the mobile PC perform encryption and decoding, so that the line lender and the like are prevented from tapping of communication data of a terminal.

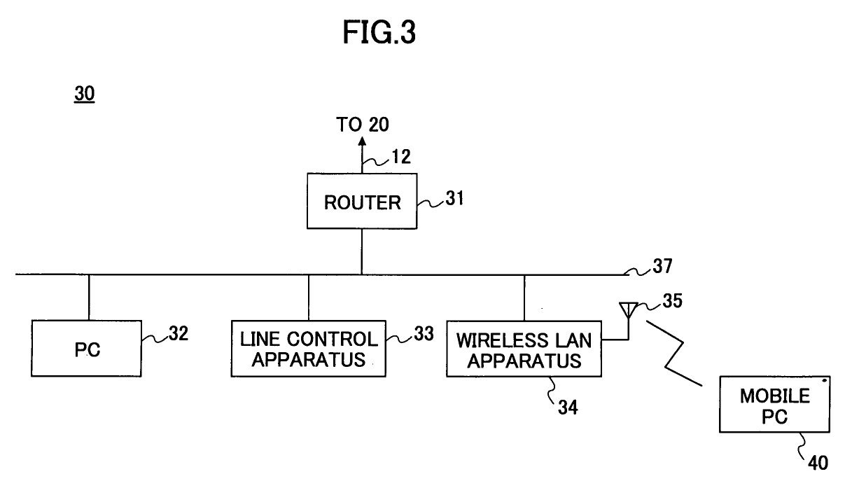

A configuration example of the line lender apparatus 30 is described next with reference to FIG. 3. The line lender apparatus 30 shown in FIG. 3 includes a router 31 for the carrier apparatus 20, a PC 32 of the line lender apparatus 30, a line control apparatus 33, a wireless LAN apparatus 34 and a LAN 37.

The line control apparatus 33 controls bandwidth to be used in the line. For example, when there is a contract between the line lender and a carrier for connecting a line of 10 gigabits per second between the carrier and the line lender, and for lending 8 megabits per second, the line control apparatus 33 changes lending bandwidth to 2 megabits per second only when the PC 32 downloads moving images, for example.

The wireless LAN apparatus 34 includes one or more access points each of which has an antenna 35. The antenna 35 sends a signal to or receives a signal from the mobile PC 40 and the like. As for the wireless LAN, for example, frequency bands of 2.4 GHZ, 5.2 GHZ, and 19 GHZ are used. At this time, communications can be performed with a communication speed of 256 Kbps-25 Mbps or more. In addition, the wireless LAN apparatus 34 communicates with the mobile PC 40, allocates an IP address to the mobile PC, and notifies the PC 32.

By the way, as a precondition of this service, the line lender of the line lender apparatus contracts beforehand with the carrier of the carrier apparatus for borrowing and lending bandwidth. The following are examples of such contract.

(1) The line lender provides the line control apparatus, wireless LAN, and pays the line use fee of the line between the line lender and the carrier. The line lender obtains a rental fee from the mobile PC. At this time, the carrier obtains a prescribed fee.

(2) The carrier installs the line control apparatus and the wireless LAN by bearing the expense. The line lender bears the expense of the line use fee of the line between the line lender and the carrier. The rental fee paid by the mobile PC is shared between the carrier and the line lender.

In addition, a contract is made regarding fees obtained by the line lender from the mobile PC. For example:

(1) The line use fee is constant regardless of usage of the line by the mobile PC.

(2) The line use fee is paid according to the usage of the line by the mobile PC (There may be a case where the line use fee to be paid by the line lender becomes minus according to the usage by the mobile PC (the line lender does not pay the line use fee, but obtains a fee).

(3) The line use fee is discounted according to the usage by the mobile PC (there is no case where the line use fee becomes minus).

In addition, the carrier makes a predetermined contract with mobile PCs, and registers information in the customer information database.

(Communication Method)

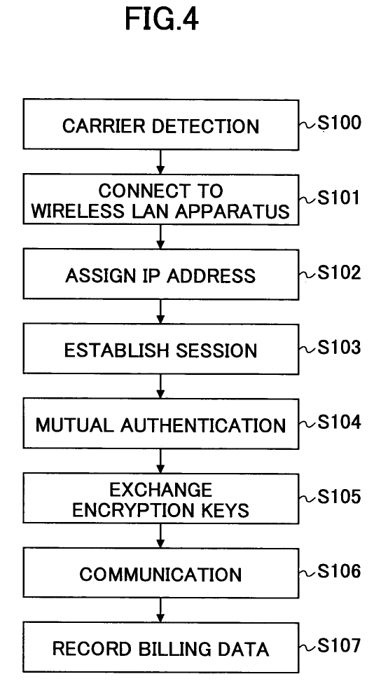

Next, the communication method is described with reference to FIG. 4 in which the mobile PC communicates with the carrier apparatus by borrowing a part or all of the bandwidth of a broadband communication line of the carrier that is used by the line lender apparatus.

A predetermined authentication software program for this service is installed in the mobile PC 40 beforehand. In addition, settings are made for using wireless LAN in the mobile PC 40.

When the mobile PC 40 is powered on, the mobile PC 40 periodically monitors the radio wave of the wireless LAN in the vicinity, and waits to receive a carrier signal (S100).

When the mobile PC 40 detects a carrier signal, the mobile PC 40 sends an originating signal. As a result, the mobile PC 40 connects to the wireless LAN apparatus 34 and authenticates the line lender apparatus 30 (S101).

After that, the wireless LAN apparatus 34 assigns an IP address and the like to the mobile PC 40 and sends a notification to the PC 32 of the IP address (S102). The PC 32 produces a packet by adding the IP address and the like to a control signal from the mobile PC 40 that is received by the wireless LAN apparatus 34, and sends the packet to the carrier apparatus 20. In addition, the PC 32 relays a control packet received from the carrier apparatus 20 to the mobile PC. Accordingly, a session is established between the mobile PC 40 and the carrier apparatus 20 (S103).

After that, the carrier apparatus 20 authenticates the mobile PC 40 on the basis of user information (ID information, authentication number and the like) sent by the mobile PC 40. In addition, at this time, the mobile PC authenticates the carrier apparatus 20 (S104).

After authenticating mutually, the mobile PC 40 and the encryption apparatus exchange the secret encryption keys used for communication (S105). After that, communication data from the mobile PC 40 are encrypted in the encryption apparatus of the mobile PC 40 by using this encryption key, and the communication data are sent once to the encryption apparatus of the carrier. The communication data are decoded in the encryption apparatus of the carrier, and transferred to the communication apparatus of the Internet. Communication data from the Internet to the mobile PC are received once by the encryption apparatus of the carrier, and the encryption apparatus encrypts the communication data and sends the data to the mobile PC 40.

The mobile PC 40 communicates with a predetermined communication apparatus 1 on the Internet (S106). When the communications end, the billing apparatus 24 records ID information and usage time in the field of the line number of a used line in the billing information database 26 (S107).

Payment of line use fee by the line lender is calculated in the following way, for example.

=line use fee+a rental fee used by mobile−(rental fee from mobile user−fee for the carrier)

In this equation, the line use fee is the intrinsic line use fee. The rental fee used by mobile is a rental fee incurred when the user uses a line of another user while on the go. The rental fee from mobile user is a rental fee revenue when another mobile user uses the line of the user. The fee for the carrier is a fee paid to the carrier.

(Cooperation with Wireless Broadband Service of Other Embodiments)

For providing the wireless broadband service, various forms can be employed other than the form in the above-mentioned embodiment in which a base station (for example, wireless LAN shown in FIG. 3) is installed by using the rental method. The forms other than the form of the above-mentioned embodiment are, for example, a form in which the carrier itself installs the base station for providing wireless services while also employing the rental method, and a form for performing mutual connection with a base station installed by another carrier.

For example, the following two forms can be used.

First form: A case where the carrier itself installs a base station while also employing the rental method

In addition to accessing the Internet via the base station installed by the line lender by using the rental method, the mobile PC is configured so as to access the Internet via the base station installed directly by the carrier.

In this case, the authentication apparatus and the billing apparatus in the carrier side are commonly used for both of the case for accessing via a base station installed by the carrier and the case for accessing via a base station of the line lender by the rental method, and a usage fee by the mobile PC is recorded in the billing apparatus. Accordingly, the usage fees for both of the case for accessing via a base station installed by the line carrier and the case for accessing via a base station of the line lender by using the rental method are added and the added fee is billed.

To the user of the mobile PC, rental fee for the line lender+usage fee of the directly operated station are billed.

Second form: A case where mutual connection with the base station installed by another carrier is performed

In addition to accessing the Internet via the base station installed by the line lender by using the rental method, the mobile PC is configured so as to access the Internet via a base station installed directly by another carrier.

When a mobile PC connects to the Internet via a base station of another carrier, the other carrier requests the authentication apparatus of the carrier to which the mobile PC subscribes to authenticate the mobile PC, and sends billing information to the billing apparatus.

In addition, rental fee for line lender+usage fee of other carrier are billed to the user of the mobile PC.

(Other Modification)

Although a case in which each home receives broadband service is described in the above-mentioned embodiment, the application of the present invention is not limited to this. The present invention is also applied to a case where a company contracts to use a bandwidth equal to or greater than a bandwidth that is normally used.

In addition, in FIG. 3, although the PC 32, the line control apparatus 33 and the wireless LAN apparatus 34 are described as separate apparatuses in the above-mentioned embodiment, a part or all of the apparatuses can be formed as one apparatus.

In addition, although a case in which a line user uses a wireless LAN is described in the above-mentioned embodiment, the means is not limited to the wireless LAN as long as the mobile PC can use the bandwidth of the line user by the means.

In addition, although a case in which the mobile PC borrows the bandwidth of the line user is described in the above-mentioned embodiment, a fixed PC (for example, a PC of the neighboring house) instead of the mobile PC may borrow the bandwidth of the line user. In this case, the line user and a PC that borrows the line of the line user need to be connected by wire or wireless. The connection is not limited to wireless LAN in this case either.

In addition, although a case is described in which the line user and the carrier are connected by a broadband Internet line in the above-mentioned embodiment, the embodiment is not limited to this example. For example, the line user and the carrier may be connected by using a private broadband line.

The carrier may be or may not be a type 1 carrier or a type 2 carrier.

Conventionally, enormous investment is required for installing base stations for providing a wireless broadband service. Thus, there is a problem in that the spread of broadband services that can be used while on the go is not sufficient. However, according to the present invention, a base station can be installed not only by the carrier but also by an individual or by a company, so that many people in a suburban area or a depopulated area can enjoy broadband service. In addition, according to the present invention, investment risk of the carrier can be reduced.

[Effects of the Present Invention]

As mentioned above, according to the present invention, the following various effects can be obtained.

According to the present invention claimed in claim 1, by communicating with the carrier apparatus by borrowing a part or all of the bandwidth of a broadband communication line, used by the line lender apparatus that lends a line, between the line lender apparatus and the carrier, mobile use of a terminal is made easier, and the communication method, the carrier apparatus and the line lender apparatus to enable borrowing and lending of a part or all of the bandwidth of a broadband communication line between the terminal and the carrier apparatus can be provided.

According to the present invention claimed in claim 2, by performing communications between the terminal and the line lender apparatus via the wireless LAN installed in the line lender apparatus, the mobile terminal can easily use the bandwidth of the line used by the line lender apparatus.

According to the present invention claimed in claim 3, by encrypting communications between the terminal and the line lender apparatus, since tapping of communication information in the line lender apparatus can be prevented, the terminal can borrow a line from the line lender apparatus without anxiety.

According to the present invention claimed in claim 4, by performing authentication mutually between the terminal and the carrier apparatus, the carrier can verify that the mobile PC is a registered one, and can verify that the mobile PC is one from which a rental fee can be collected with reliability. In addition, the mobile PC can verify that it connects to a valid carrier by authenticating the carrier apparatus.

According to the present invention claimed in claim 5, before the terminal in the present invention performs communications via the line lender apparatus, the terminal and the line lender apparatus can authenticate each other. Accordingly, an invalid third party's use of the line lender apparatus without permission so that the invalid third party performs communication just like a valid terminal of the line lender can be prevented.

According to the present invention claimed in claim 6, since a fee to be paid to the carrier can be decreased according to the amount of line bandwidth that is lent by the line lender apparatus, expenses of line use imposed on the line lender can be reduced, so that the spread of broadband can be accelerated.

According to the present invention claimed in any one of claims 7-11, a carrier apparatus applicable to the communication method claimed in any one of claims 1-6 can be provided.

According to the present invention claimed in claim 12 or 13, a line lender apparatus applicable to the communication method claimed in any one of claims 1-6 can be provided.

The present invention is not limited to the specifically disclosed embodiments, and variations and modifications may be made without departing from the scope of the invention.

1. A communication method in which a terminal communicates with a communication apparatus on the Internet via a carrier apparatus, wherein:
the terminal communicates with the carrier apparatus by borrowing a part or all of bandwidth of a broadband communication line, used by a line lender apparatus that lends a line, between the line lender apparatus and the carrier apparatus.

2. The communication method as claimed in claim 1, wherein the communication between the terminal and the line lender apparatus is performed via a wireless LAN that is provided in the line lender apparatus.

3. The communication method as claimed in claim 1 or 2, wherein the communication between the terminal and the carrier apparatus is performed by encrypting a sending signal in the sending side and decoding a received signal in the receiving side.

4. The communication method as claimed in any one of claims 1-3, wherein the terminal and the carrier apparatus authenticate each other before the terminal communicates with the communication apparatus on the Internet via the carrier apparatus.

5. The communication method as claimed in any one of claims 1-3, wherein the terminal and the line lender apparatus authenticate each other before the terminal performs communication via the line lender apparatus.

6. The communication method as claimed in any one of claims 1-5, wherein a fee to be paid to the carrier is decreased according to an amount of line that is lent.

7. A carrier apparatus that mediates between a terminal and a communication apparatus on the Internet, wherein the communications between the terminal and the carrier apparatus are performed by using a part or all of bandwidth of a broadband communication line, used by a line lender apparatus that lends a line, between the line lender apparatus and the carrier.

8. The carrier apparatus as claimed in claim 7, the carrier apparatus comprising an authentication apparatus, wherein:
the authentication apparatus includes a customer information database that stores information on customers of the carrier;
the authentication apparatus authenticates the terminal by referring to the customer information database before the terminal performs communications with the communication apparatus on the Internet.

9. The carrier apparatus as claimed in claim 8, wherein the authentication apparatus authenticates the terminal by obtaining, from the terminal, authentication information that is stored in an IC card included in the terminal.

10. The carrier apparatus as claimed in any one of claims 7-9, the carrier apparatus comprising a billing apparatus, wherein:
the billing apparatus includes a billing information database that stores billing information;
the billing apparatus records an amount of line that is lent for each line lender; and
when the carrier apparatus calculates a billing fee for use of a line by the line lender wherein the lent line is owned by the carrier, the billing apparatus subtracts an amount from the fee according to an amount of the line that is lent on the basis of data recorded in the billing information database.

11. The carrier apparatus as claimed in any one of claims 7-10, the carrier apparatus comprising an encryption part for encrypting a sending signal to the terminal or a decoding part for decoding an encrypted signal received from the terminal.

12. A line lender apparatus for lending bandwidth of a line between a carrier apparatus and the line lender apparatus, wherein:
the line lender apparatus is provided with a wireless base station for relaying a signal between a line borrower apparatus and the carrier apparatus;
the line lender apparatus sends a signal sent from the line borrower apparatus that is received by the wireless base station to the carrier apparatus over a line between the line lender apparatus and the carrier apparatus that is used by the line lender apparatus; and
the line lender apparatus sends a signal sent from the carrier apparatus to the line borrower apparatus via the wireless base station.

13. The line lender apparatus as claimed in claim 12, the line lender apparatus comprising authentication means for authenticating, wherein:
before a terminal performs communications via the line lender apparatus, the authentication means and the terminal authenticate each other.
